(19) United States
(12) Patent Application Publication
(10) Pub. No.: US 2026/0058042 A1
(43) Pub. Date: Feb. 26, 2026

(54) PREFORM, PREFORMING METHOD, AND METHOD OF PRODUCING COMPRESSION-BONDED MAGNET

(71) Applicant: AICHI STEEL CORPORATION, Tokai-shi, Aichi-ken (JP)

(72) Inventor: Yuki TSUGE, Aichi-ken (JP)

(73) Assignee: AICHI STEEL CORPORATION, Tokai-shi, Aichi-ken (JP)

(21) Appl. No.: 18/880,411

(22) PCT Filed: Aug. 2, 2022
(86) PCT No.: PCT/JP2022/029704

§ 371 Date: Nov. 6, 2025

(51) Int. Cl. H01F 1/08; B22F 1/16

(52) U.S. Cl. CPC H01F 1/083; B22F 1/16; B22F 2301/355; B22F 2302/45

(57) ABSTRACT

A preform maintains shape retention properties and handling ability while suppressing deterioration in bonded magnet magnetic characteristics. A preform having an outer shell portion formed by binding a part of a magnet raw material of a mixture or kneaded product of magnet particles and a thermosetting resin that is powdery or granular, and an inner encapsulated portion formed of a remainder of the magnet raw material present inside the outer shell portion which maybe a portion in which the thermosetting resin has bound while still uncured. The inner encapsulated portion includes a powdery or granular magnet raw material. The preform is obtained by a preforming step of subjecting the magnet raw material to warm pressurization compacting, and maybe carried-out by setting a preforming temperature (Tp), which is the temperature of a preforming mold inner wall surface to be filled with magnet raw material, to ts≤Tp≤ts+20° C. (ts: thermosetting resin softening point).

### TECHNICAL FIELD

The present invention relates to a preform used in the production of a compression-bonded magnet and relevant techniques.

### BACKGROUND ART

Permanent magnets are often used in electromagnetic devices (such as electric motors) to save energy. Permanent magnets include sintered magnets that are obtained by sintering magnet powder and bonded magnets that are obtained by bonding magnet powder with resin. The bonded magnets have a large degree of freedom in the shape and are more excellent in the moldability than the sintered magnets.

Major examples of the bonded magnets include injection-bonded magnets, which are obtained by injecting a molten mixture of magnet powder and thermoplastic resin into a cavity and molding it in the cavity, and compression-bonded magnets, which are obtained by heating and compression-molding a mixture or kneaded product of magnet powder and thermosetting resin (simply referred to as a “magnet raw material”) in a cavity. The compression-bonded magnets usually have a higher proportion of magnet powder than injection-bonded magnets, have high magnetic characteristics, and are also excellent in heat resistance and the like because they use thermosetting resin.

When producing compression-bonded magnets, if a powdery or granular magnet raw material is filled directly into a high-temperature cavity, the softening or melting of the previously filled magnet raw materials (especially the resin) may cause problems such as a decrease in filling properties and non-homogenization in the cavity (distribution variation of magnet particles and thermosetting resin). To solve such problems, a preform (temporarily compressed compact) obtained by preliminarily subjecting a powdery or granular magnet raw material to low-pressure compacting is put into a cavity and then subjected to heat compression molding (referred to as “main molding”). Descriptions relevant to this are found, for example, in the following patent document.

### PRIOR ART DOCUMENTS

### Patent Documents

Patent Document 1: JP2013-256684A

### SUMMARY OF INVENTION

### Technical Problem

Patent Document 1 discloses producing a compression-bonded magnet through pressurizing a resin composition for bonded magnets at 0.1-0.2 t/cm² (about 10-20 MPa) in the room temperature range (unheated state) to obtain a temporarily compressed compact and feeding it into a high-temperature cavity placed directly below the compact without contact. The temporarily compressed compact (preform) subjected to low-pressure compacting in the room temperature range tends to crumble and is difficult to transport, so Patent Document 1 addresses this by placing a preforming mold and a main molding mold close to each other above and below.

The present invention has been made in view of such circumstances, and objects of the present invention include providing a preform of a novel form having shape retention properties that enable transportation or the like and providing relevant products and techniques.

### Solution to Problem

As a result of intensive studies to achieve the above object, the present inventor has conceived of a preform with a core-shell structure and successfully obtained a preform having desired shape retention properties by subjecting a magnet raw material to warm compacting. Developing this achievement, the present inventor has accomplished the present invention, which will be described below.

### Preform

(1) The present invention provides a preform having an outer shell portion and an inner encapsulated portion. The outer shell portion is formed by binding a part of a magnet raw material that is powdery or granular. The magnet raw material is composed of a mixture or kneaded product of magnet particles and a thermosetting resin. The inner encapsulated portion is formed of a remainder of the magnet raw material present inside the outer shell portion.
(2) The preform of the present invention is in a core-shell structure having an outer shell portion and an inner encapsulated portion, rather than being a homogeneous compact of magnet raw material. The outer shell portion (shell portion) is formed by binding (linking, bonding, etc.) a part of the magnet raw material, and is responsible for the strength required for the shape retention and handling of the preform, etc. The inner encapsulated portion (core portion) does not require such strength, and is responsible for a low-density state suitable for the production of a compression-bonded magnet. According to the preform of the present invention, it is possible to ensure both the handling properties and the magnetic characteristics of the bonded magnet at a high level.

### Preforming Method

The present invention is also perceived as a method of producing a preform. For example, the present invention may provide a preforming method that includes a preforming step of subjecting a magnet raw material to warm pressurization compacting. The magnet raw material is composed of a mixture or kneaded product of magnet particles and a thermosetting resin.

### Method of Producing Compression-Bonded Magnet

The present invention is also perceived as a method of producing a compression-bonded magnet. For example, the present invention may provide a method of producing a compression-bonded magnet, including a main molding step of subjecting the preform to heat compression molding.

### Compression-Bonded Magnet/Magnetic Member

The present invention is also perceived as a compression-bonded magnet, a magnetic member (electromagnetic member) in which a compression-bonded magnet is integrally molded in a cavity of a housing, or the like. In the present specification, a compression-bonded magnet will be simply referred to as a “bonded magnet” as appropriate, hereinafter.

### Others

Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit. Unless otherwise stated, a range “x-y μm” as referred to in the present specification means x μm to y μm. The same applies to other unit systems (such as kA/m and kOe).

### BRIEF DESCRIPTION OF DRAWINGS

FIG. 1 is a scatter diagram illustrating the relationships between compacting conditions for preforms and their apparent densities.

FIG. 2A is a set of photographs showing the appearance and fracture mode of a preform subjected to warm compacting.

FIG. 2B is a set of photographs showing the appearance and fracture mode of a preform subjected to ordinary-temperature compacting.

FIG. 3 is a set of photographs obtained by observing the outer surfaces of a preform subjected to warm compacting and a preform subjected to ordinary-temperature compacting with a microscope.

FIG. 4 is a scatter diagram illustrating the effect of the apparent density/relative density of a preform on the orientation ratio of a bonded magnet.

### EMBODIMENTS FOR CARRYING OUT THE INVENTION

One or more features freely selected from the matters described in the present specification can be added to the above-described features of the present invention. Methodological features regarding a production method can also be features regarding a product. Which embodiment is the best or not is different in accordance with objectives, required performance, and other factors.

### Magnet Raw Material

The magnet raw material is composed of a mixture or kneaded product of magnet particles (powder) and a thermosetting resin (powder), and is powdery or granular. The mixture may be in a powder form obtained by mixing the thermosetting resin and the magnet particles in the ordinary temperature range, or in a granular form obtained by mixing the thermosetting resin and the magnet particles while heating them. The kneaded product is in a granular form obtained by kneading (particularly heating and kneading) the magnet particles and the thermosetting resin. The magnet raw material in a granular form is composed of composition particles (simply referred to as a “compound”) in which the thermosetting resin is attached approximately uniformly to the surfaces of the magnet particles. In the kneaded compound, the thermosetting resin attached to the surfaces of the magnet particles is more likely to be dense than in the mixed compound. The thermosetting resin used for production of the compound may not have to be in a solid form (such as a particulate form).

Heating of the thermosetting resin and magnet particles is performed, for example, in a warm state (e.g., 40-120° C. in an embodiment or 80-100° C. in another embodiment). By mixing or kneading the thermosetting resin in a fluid state (softened or molten state), cracking of the magnet particles can be suppressed.

### Magnet Particles

The magnet particles may be of a single type or of multiple types. Multiple types of magnet particles are obtained by mixing powders that differ in at least one of the alloy composition, particle diameter (particle size distribution), characteristics (anisotropy/isotropy), etc.

The magnet particles may be, for example, a mixed powder of coarse powder and fine powder with different average particle diameters. The average particle diameter of the coarse powder is, for example, 40-200 μm in an embodiment or 80-160 μm in another embodiment. The average particle diameter of the fine powder is, for example, 1-10 μm in an embodiment or 2-6 μm in another embodiment. The average particle diameter is determined, for example, by measurement (measurement using the Fraunhofer method) with a laser diffraction-type particle size distribution measuring device (HELOS available from Japan Laser Corporation).

The mass ratio of the coarse powder to the total of the coarse powder and the fine powder (or to the entire magnet powder) is, for example, 60-90 mass % in an embodiment or 65-80 mass % in another embodiment. In other words, the mass ratio of the fine powder to the total is, for example, 10-40 mass % in an embodiment or 20-35 mass % in another embodiment. The ratio of the magnet particles to the magnet raw material (total of the magnet particles and the resin (including additives)) is, for example, 88-98 mass % in an embodiment, 91-95 mass % in another embodiment, or 92-94 mass % in still another embodiment.

Examples of the magnet particles include rare earth magnet particles. Examples of the rare earth magnet particles include NdFeB-based ones containing Nd, Fe, and B as basic components, SmFeN-based ones containing Sm, Fe, and N as basic components, and SmCo-based ones containing Sm and Co as basic components. As one example, the magnet particles may be mixed particles of coarse particles composed of NdFeB-based anisotropic magnet particles and fine particles composed of SmFeN-based anisotropic magnet particles or SmCo-based anisotropic magnet particles. The magnet particles may also include rare earth isotropic magnet particles and ferrite particles.

### Thermosetting Resin

The thermosetting resin serves as a binder that holds the magnet particles. Examples of the thermosetting resin include epoxy resins, phenol resins, melamine resins, urea resins, and unsaturated polyester resins. A typical epoxy resin is composed, for example, of a mixture of a base resin (prepolymer) and a curing agent, and is cured by cross-linkage networking with epoxy groups. Examples of the base resin to be used for the epoxy resin include novolak-type, bisphenol A-type, bisphenol F-type, biphenyl-type, naphthalene-type, aliphatic-type, and glycidylamine-type ones. Examples of the curing agent to be used for the epoxy resin include amine-based, phenol-based, and acid anhydride-based ones. At least one of the base resin and the curing agent may be two or more types of resins. A one-component epoxy resin whose timing of thermosetting can be adjusted by curing treatment (thermosetting step) may be used.

The thermosetting resin may be a resin composition containing additives such as a curing accelerator and a mold release agent. In the present specification, such a resin composition is also simply referred to as a “thermosetting resin.” The magnet particles may be subjected to coating treatment using a surfactant corresponding to the thermosetting resin. In the present specification, the magnet particles that have been subjected to such surface treatment are also simply referred to as “magnet particles.” Examples of surfactants corresponding to epoxy resins include titanate-based coupling agents and silane-based coupling agents.

### Preform

(1) The preform has an outer shell portion and an inner encapsulated portion. The outer shell portion is formed by binding a part of the magnet raw material (especially the thermosetting resin). The inner encapsulated portion is formed of the remainder of the magnet raw material present inside the outer shell portion.

The outer shell portion may be in a state in which the particles of the magnet raw material (mixed magnet particles and thermosetting resin particles, or compound) are simply pressed together (compacted state). It is preferred that at least a part of the outer surface of the outer shell portion should be provided with a linked portion in which the thermosetting resin constituting the magnet raw material is integrated over a plurality of particles (between two or more thermosetting resin particles or between two or more compound particles). The linked portion is formed, for example, in such a manner that the thermosetting resin comes into contact with the inner wall surface of a heated mold to soften and melt and then re-solidifies between adjacent particles of the magnet raw material. As a matter of course, the outer edge of the linked portion where the thermosetting resin is integrated is expanded (enlarged) more than the outer edge of the thermosetting resin constituting the magnet raw material particles. The linked portion may be a layer or film of softened thermosetting resin or the like that spreads to wet and cover the entire outer surface of the outer shell portion, or may be dotted on the outer surface of the outer shell portion in the form of islands. The thermosetting resin in the outer shell portion, as well as in the inner encapsulated portion, may be in a substantially uncured state in which the curing reaction (crosslinking reaction) progresses little.

The magnet raw material in the inner encapsulated portion may be in a compacted state, a powdery state, a granular state, or a mixture of these. The closer the magnet raw material in the inner encapsulated portion is to the state before preforming, the more the magnetic characteristics of the bonded magnet can be improved.

The preform has a relative density (ρ/ρ₀), which is the ratio of an apparent density (ρ) to a true density (ρ₀), of 48-72% in an embodiment, 50-70% in another embodiment, or 55-65% in still another embodiment, for example. The true density is obtained from the density and compounding ratio of the magnet particles and thermosetting resin that constitute the magnet raw material. The apparent density is obtained by dividing the mass of the preform by its apparent volume (e.g., the volume calculated from the external dimensions).
(2) The preform is obtained, for example, by subjecting the magnet raw material to warm pressurization compacting (preforming step). The preforming step may be carried out by setting a preforming temperature (Tp), which is a temperature of the inner wall surface of a preforming mold that is to be filled with the magnet raw material, to a temperature of ts≤Tp≤ts+20° C. (ts: softening point of thermosetting resin) in an embodiment or a temperature of ts+5° C.≤Tp≤ts+15° C. in another embodiment.

Methods for measuring the softening point include a ring-and-ball method (ASTM D36) and a cup-and-ball method (ASTM D3461). In both methods, a weight is placed on the material filling a cylindrical container and heated, and the softening point is determined as a temperature at which the weight extrudes the softened material to a predetermined value.

The softening point (ts) according to the present invention may be an actually measured value or may also be a softening point listed in a catalogue or the like. When the thermosetting resin is a resin composition composed of two or more types of resins, the softening point (ts) may be a softening point calculated in accordance with Rule-of-Mixture from the compounding ratio of the resins (e.g., base resin and curing agent) and the known softening point of each resin.

When the thermosetting resin is composed of two or more types of resins, the intermediate temperature of the softening points of the resins may be adopted as the preforming temperature (Tp). For example, when the thermosetting resin includes at least a first resin having a first softening point (ts1) and a second resin having a second softening point (ts2) higher than the first softening point, the preforming step may be carried out by setting the preforming temperature (Tp), which is a temperature of the inner wall surface of a preforming mold that is to be filled with the magnet raw material, to a temperature of ts1≤Tp≤ts2. If the thermosetting resin is composed of three or more types of resins with different softening points, the first softening point (first resin) and the second softening point (second resin) may be selected arbitrarily.

When the thermosetting resin is composed of two or more types of resins and among their softening points the first softening point (ts1) is lowest while the second softening point (ts2) is highest, the preforming temperature (Tp) may be higher than the first softening point and lower than the second softening point (ts1<Tp<ts2). In other words, the preforming temperature (Tp) may be an intermediate temperature between the lowest softening point (tsm1) and the highest softening point (tsm2) (tsm1<Tp<tsm2).

When the preforming temperature is near the softening point of the thermosetting resin, it is easy to adjust the compacting pressure and compacting time in the preforming step. If the preforming temperature is unduly low or high relative to the softening point, it may be difficult to form the desired outer shell portion and inner encapsulated portion.

The preforming step may be performed with a compacting pressure of, for example, 0.1-100 MPa in an embodiment, 0.5-50 MPa in another embodiment, or 1-10 MPa in still another embodiment. If the compacting pressure is unduly low, compacting itself of the preform may be difficult. Unduly high compacting pressure may lead to cracking of the magnet particles, an increase in the density of the preform, etc.

It is sufficient to perform the preforming step by setting the compacting time, for example, to 1-20 seconds in an embodiment or 1-5 seconds in another embodiment. By making the compacting time relatively short, a preform having the desired outer shell portion and inner encapsulated portion can be efficiently obtained.
(3) The preform may be in any form that enables filling, loading, putting, etc. into a cavity to mold the bonded magnet. The preform may be a one-piece body that approximates the bonded magnet or may also be a divided body that is subdivided in accordance with the bonded magnet. The shape of the preform may be along the shape of a cavity used in the main molding step. Usually, a mold different from that used in the main molding step is used in the preforming step.

### Main Molded Body/Main Molding Step

(1) The main molded body to be the bonded magnet is obtained by subjecting the preform to heat compression molding in a cavity (main molding step). When the magnet raw material contains anisotropic magnet particles (particularly rare earth anisotropic magnet particles), the main molding step may be carried out while applying an oriented magnetic field to the cavity in which the preform is placed.

The molding pressure (compression force) is, for example, 5-500 MPa in an embodiment, 10-250 MPa in another embodiment, 20-100 MPa in still another embodiment, or 30-50 MPa in yet another embodiment. If the compression force is unduly high, troubles may occur, such as deformation of the bonded magnet or cavity and cracking of the magnet particles (particularly those obtained by subjecting the magnet alloy to hydrogen treatment (HDDR, d-HDDR). If the compression force is not unduly low, even low-pressure molding (e.g., 100 MPa or less) allows the obtained bonded magnet to exhibit high Br and high Hk. Hk represents the magnitude of the reverse magnetic field at a magnetic flux density equivalent to 90% of Br (residual magnetic flux density), and is an index of the effective magnetic flux density against the reverse magnetic field or an index of the squareness of the magnetization curve (J-H curve).

The molding temperature (heating temperature) is, for example, 120-200° C. in an embodiment or 130-170° C. in another embodiment. If the heating temperature is unduly low, the thermosetting resin will be insufficiently softened or melted, which may cause cracking of the magnet particles, a decrease in the orientation ratio, etc. If the heating temperature is unduly high, early curing of the thermosetting resin, oxidation degradation of the magnet particles, etc. will lead to poor magnetic characteristics of the bonded magnet.

The oriented magnetic field is usually applied in an orientation direction that crosses (or is orthogonal to) a compression direction for the preform (magnet raw material). The magnitude of the oriented magnetic field is, for example, 0.5-3 T in an embodiment or 1-2 T in another embodiment. The oriented magnetic field represents a magnetic flux density on the inner circumferential surface of a cavity in which the bonded magnet is molded. The magnetizing source for the oriented magnetic field may be an electromagnet or a (rare earth) permanent magnet.
(2) The main molded body may be used as the bonded magnet without any modification. The bonded magnet may also be obtained by magnetizing the main molded body and/or by subjecting it to a heat treatment (curing treatment) to cure the resin. The curing treatment is performed by heating the main molded body at a temperature depending on the type of the thermosetting resin. The heating temperature is, for example, 130-250° C. in an embodiment or 150-230° C. in another embodiment.

Magnetization may be performed by applying a magnetic field of, for example, about 2-6 T. The bonded magnet subjected to the heat compression molding in an oriented magnetic field may not necessarily have to be magnetized, but magnetization is expected to improve the magnetic characteristics of the bonded magnet.

The bonded magnet may be one that is released (ejected) from the cavity after the main molding step, or one that is integrated during the main molding step with a housing having a cavity (such as a slot). Examples of a magnetic member in which the bonded magnet is integrated into the cavity of a housing include field magnet elements (rotors, stators) of electric motors (motors for driving vehicles, motors for air conditioners and home appliances, etc.). Electric motors may be DC motors or AC motors. Electric motors include not only motors but also generators.

### EXAMPLES

A number of preforms (samples) were produced by variously changing the compacting conditions. In addition, bonded magnets were produced using the preforms. Their appearances and characteristics were evaluated. The present invention will be described in detail below based on such specific examples.

### Production of Samples

### (1) Magnet Powders and Thermosetting Resin

Magnet powders used are a commercially available NdFeB-based anisotropic magnet powder that is coarse powder produced by hydrogen treatment (d-HDDR) (MAGFINE available from AICHI STEEL CORPORATION/Br: 1.28 T, iHc: 1313 kA/m, average particle diameter: 125 μm) and a commercially available SmFeN-based anisotropic magnet powder that is fine powder (SmFeN alloy fine powder C available from Sumitomo Metal Mining Co., Ltd./Br: 1.35 T, iHc: 875 kA/m, average particle diameter: 3 μm).

An epoxy resin composed of the base resin (first resin) and the curing agent (second resin) listed in Table 1 was used as the thermosetting resin. Both were powdery in the ordinary temperature region. In this example, a resin composition was prepared by compounding the epoxy resin with a curing accelerator and a release agent (both of which are collectively referred to as “additives”) listed in Table 1. In the present specification, the resin composition containing the additives is also simply referred to as an “epoxy resin.”

The resin composition placed on a hot plate began to deform (soften) when the surface temperature of the hot plate reached about 60° C. The temperature was approximated to the softening point calculated from the softening point of the base resin (ts1), the softening point of the curing agent (ts2), and their compounding ratio: (53° C.×100+65° C.×74.4)/(100+74.4)≈58.1° C. (about 59° C.).

### (2) Magnet Raw Material

A mixture of the magnet powder (coarse powder and fine powder) and the thermosetting resin was mixed in a kneader while heating them (referred to as “melting and mixing” as appropriate) to prepare a granular compound (kneaded product/magnet raw material). The compounding ratio of the mixture was, in mass ratio to the whole, 65.2 mass % coarse powder, 27.9 mass % fine powder, and 6.9 mass % thermosetting resin (including additives). The true density (ρ₀) of the magnet raw material obtained from respective true densities and the compounding ratio is 5.6 g/cm³.

In terms of the volume ratio, the ratio of the magnet powder (coarse powder and fine powder) to the thermosetting resin is 7:3. The volume ratio of the coarse powder to the fine powder is almost the same as their mass ratio, 7:3.

Kneading was performed by maintaining the container body of the kneader at 90° C. and rotating the kneader at a low speed (10 rpm) for 5 minutes (melting and mixing step). At that time, the thermosetting resin was in a softened or melted state. However, since the melting and mixing were performed at a low temperature for a short time, the thermosetting resin was in a state of being almost not thermally cured.

### (3) Preforming Step

The compound was loaded into the cavity of the preforming mold to produce rectangular preforms (upper and lower surfaces: 13.8 mm square). The temperature of the inner wall surface of the cavity (mold side wall temperature) was set to about 23° C. (ordinary temperature), 60° C. or 65° C. (warm temperature), or 150° C. (hot temperature). These temperatures were measured by a thermocouple embedded in the vicinity of the inner wall of the mold. The compacting pressure was variously changed (0.15-500 MPa) for each temperature.

### (4) Main Molding Step

Each preform subjected to the warm compacting was loaded into the cavity of the main molding mold and compression-molded in a heated and oriented magnetic field. During this operation, the inner wall temperature of the cavity was 150° C., and the molding pressure (compression force) was 20 MPa. The orientation direction was a direction (lateral direction) orthogonal to the compression direction (axial direction), and the oriented magnetic field was variously changed (5-18 kOe/398-1432 kA/m). Thus, rectangular main molded bodies (upper and lower faces: 14 mm square) were obtained.

A main molded body was also produced as a comparative sample without using a preform through directly loading a granular compound into the cavity of the main molding mold and subjecting the granular compound to heat compression molding in an oriented magnetic field in the same manner as above.

### (5) Heat Treatment Step

The main molded bodies each taken out from the cavity of the mold were heated in the air at 150° C. for 30 minutes (curing treatment). Thus, bonded magnets were obtained in which the thermosetting resin was thermally cured. Each bonded magnet was also magnetized by applying a magnetic field of 6 T to the magnet using an air-core coil (magnetization step).

### Observation/Measurement

### (1) Compacting Pressures for Preforms and Apparent Densities (ρ)

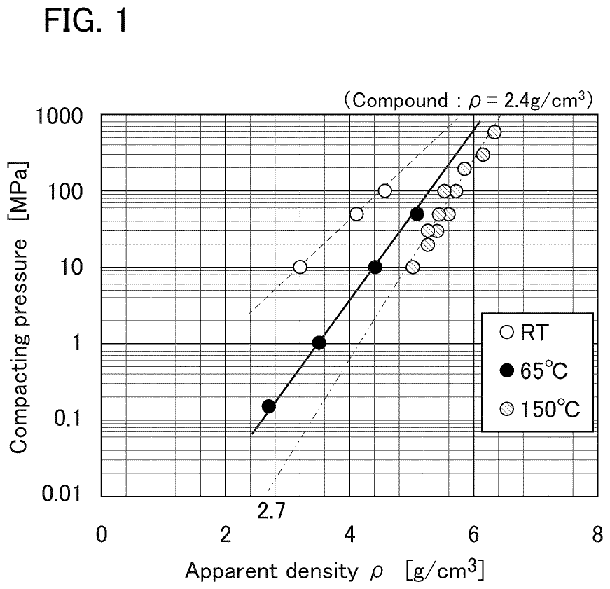

The apparent densities (ρ) of respective preforms with different compacting temperatures and compacting pressures were obtained. The apparent density was obtained through measuring the mass and dimensions of each preform and dividing the mass by the volume calculated from the dimensions. The relationships between them are collectively illustrated in FIG. 1.

### (2) Appearances and Fracture Modes of Preforms

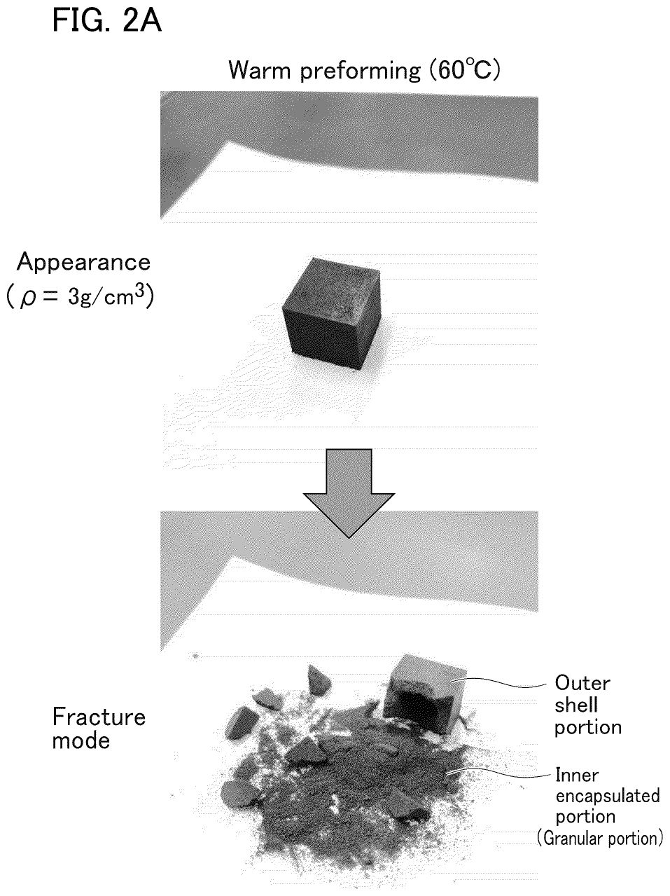

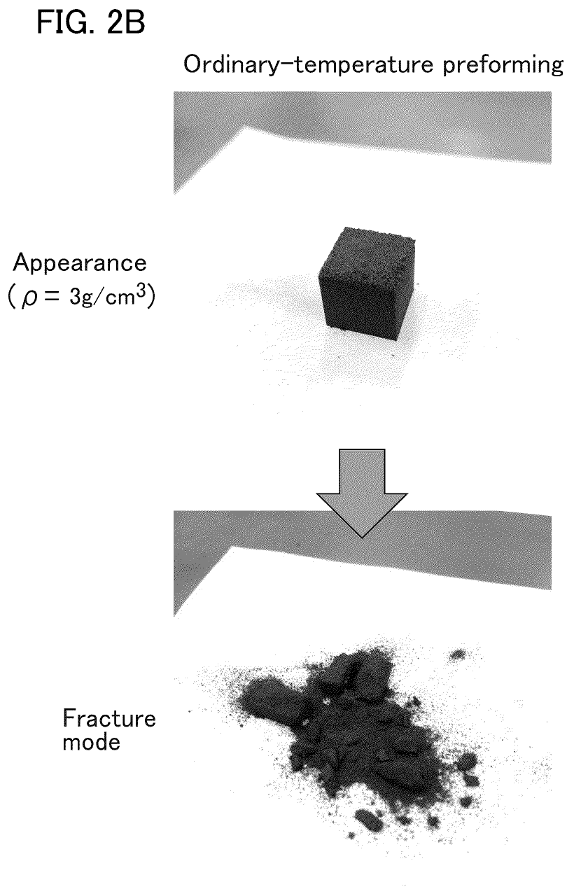

For the preform subjected to warm compacting (ρ=3 g/cm³) and the preform subjected to ordinary-temperature compacting (ρ=3 g/cm³), respective appearances and fracture modes are shown in FIGS. 2A and 2B (collectively referred to as “FIG. 2”). The fracture mode shows the state when the preform was lightly hit with a plastic hammer.

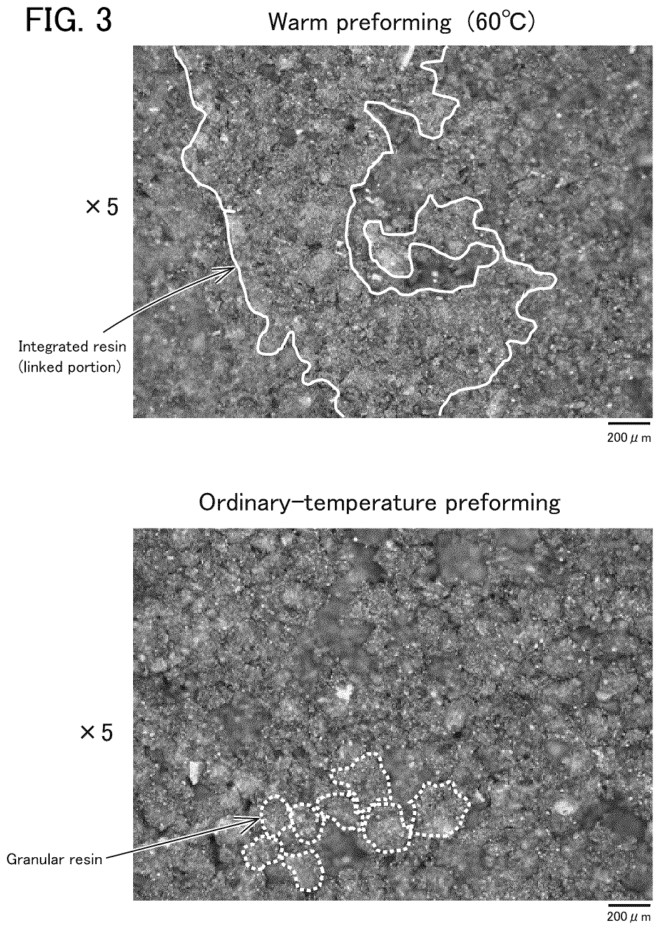

In addition, the outer surfaces of the preforms were observed with an optical microscope. The observed images of the preforms are shown in FIG. 3. The boundary (outer edge) of the resin that appeared on the surface (part) of each preform is shown by a solid line or a dashed line.

### (3) Orientation Ratios of Bonded Magnets

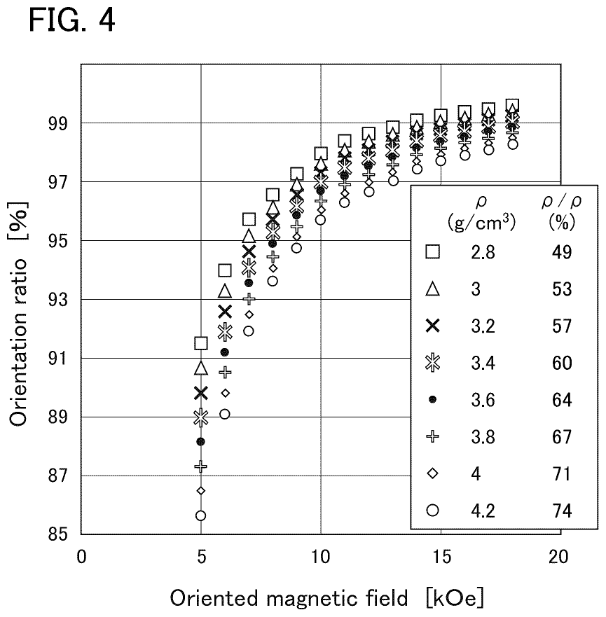

The orientation ratios were obtained from the magnetic characteristics of the bonded magnets. The relationships between the orientation ratios, the oriented magnetic fields in the main molding step, and the apparent densities (ρ[g/cm³]) or relative densities (%) of the preforms are collectively illustrated in FIG. 4.

Here, the magnetic characteristics of the bonded magnets were obtained from the B-H curve determined by ordinary-temperature measurement using a DC BH tracer (TRF-5BH-25Auto, available from Toei Industry Co., Ltd.). The relative density (ρ/ρ₀ [%]) was obtained by dividing the apparent density (ρ) of the preform by the true density (ρ₀) of the magnet raw material.

The orientation ratio was calculated by dividing the residual magnetic flux density (Brx) when each orientation magnetic field (kOe) was applied by the residual magnetic flux density (Br0) when an orientation magnetic field of 20 kOe (1591 kA/m) was applied.

### Evaluation

### (1) Apparent Densities of Preforms

As found from FIG. 1, a preform with an apparent density close to the bulk density of the powdery compound (ρ: 2.4 g/cm³) was obtained by warm low-pressure compacting.

### (2) Shape Retention Properties of Preforms

As found from FIG. 2A, the preform subjected to warm compacting was formed with an outer shell portion (shell portion), and the inside (inner encapsulated portion/core) was granular compound. On the other hand, as found from FIG. 2B, the preform subjected to ordinary-temperature compacting was formed with no outer shell portion (shell portion), and even a light impact caused the whole to collapse into granular form.

Such a difference is thought to be due to the form of the thermosetting resin near the outer surface of the preform (presence or absence of a linked portion), as shown in FIG. 3.

### (3) Orientation Ratios of Bonded Magnets

As found from FIG. 4, the lower the apparent density of the preform, the higher the orientation ratio of the bonded magnet, regardless of the magnitude of the oriented magnetic field. It has also been found that the orientation ratios of bonded magnets made using preforms with an apparent density of 2.8 g/cm³ were almost the same as the orientation ratio of a bonded magnet made using a granular compound without any modification.

From the above, it has been found that a preform having an outer shell portion and an inner encapsulation portion can ensure the shape retention properties (and therefore handling ability) while suppressing the deterioration in the magnetic characteristics of the bonded magnet.

TABLE 1

| | | Softening | Melting | |
|---|---|---|---|---|
| | Compounding | point | point | |
| Type | ratio (phr) | (° C.) | (° C.) | Product name/Provider |
| Base resin | 100 | 53 | — | NC-3000-L available from Nippon Kayeku Co., Ltd. |
| Curing agent | 74.4 | 65 | — | GPH-65 available from Nippon Kayaku Co., Ltd. |
| Curing accelerator | 3 | — | 203 | TPP-S available from HOKKO CHEMICAL INDUSTRY CO., LTD. |
| Release agent | 2.6 | — | 84 | Carnauba Wax available from CERARICA NODA Co., Ltd. |

1. A preform comprising:
an outer shell portion formed by binding a part of a magnet raw material that is powdery or granular, the magnet raw material comprising a mixture or kneaded product of magnet particles and a thermosetting resin; and
an inner encapsulated portion formed of a remainder of the magnet raw material present inside the outer shell portion.

2. The preform according to claim 1, wherein at least a part of an outer surface of the outer shell portion is provided with a linked portion in which the thermosetting resin is integrated over a plurality of particles.

3. The preform according to claim 1, wherein at least a part of the inner encapsulated portion is powdery or granular.

4. The preform according to claim 1, wherein the magnet particles are contained in an amount of 88-98 mass % with respect to the magnet raw material as a whole.

5. The preform according to claim 1, wherein the magnet particles include rare earth anisotropic magnet particles.

6. The preform according to claim 1, wherein a relative density (ρ/ρ₀) that is a ratio of an apparent density (ρ) to a true density (ρ₀) is 48-72%.

7. A preforming method comprising a preforming step of subjecting a magnet raw material to warm pressurization compacting, the magnet raw material comprising a mixture or kneaded product of magnet particles and a thermosetting resin,
wherein the preform according to claim 1 is obtained.

8. The preforming method according to claim 7, wherein the preforming step is carried out by setting a preforming temperature (Tp) to a temperature between a softening point (ts) of the thermosetting resin and the softening point +20° C. (ts≤Tp≤ts+20° C.), wherein the preforming temperature is a temperature of an inner wall surface of a preforming mold that is to be filled with the magnet raw material.

9. The preforming method according to claim 7, wherein
the thermosetting resin includes at least a first resin having a first softening point (ts1) and a second resin having a second softening point (ts2) higher than the first softening point, and
the preforming step is carried out by setting a preforming temperature (Tp) to a temperature between the first softening point and the second softening point (ts1≤Tp≤ts2), wherein the preforming temperature is a temperature of an inner wall surface of a preforming mold that is to be filled with the magnet raw material.

10. The preforming method according to claim 9, wherein among softening points of resins constituting the thermosetting resin, the first softening point (ts1) is lowest and the second softening point (ts2) is highest, and
the preforming temperature (Tp) is higher than the first softening point and lower than the second softening point (ts1<Tp<ts2).

11. A method of producing a compression-bonded magnet, comprising a main molding step of subjecting the preform according to claim 1 to heat compression molding.

12. The method of producing a compression-bonded magnet according to claim 11, wherein
the magnet particles include anisotropic magnet particles, and
the main molding step is carried out while applying an oriented magnetic field to a cavity in which the preform is placed.
